(19) United States
(12) Patent Application Publication
(10) Pub. No.: US 2021/0332547 A1
(43) Pub. Date: Oct. 28, 2021

(54) Device to Prevent Marl Erosion in Reserved Water and Mud Waste Pits at Drilling Sites

(71) Applicant: Saudi Arabian Oil Company, Dhahran (SA)

(72) Inventor: Serguey Viktorov Arkadakskiy, Edmonton (CA)

(21) Appl. No.: 16/855,542

(22) Filed: Apr. 22, 2020

(51) Int. Cl. E02B 3/12; E21B 21/01; E02B 3/16

(52) U.S. Cl. CPC E02B 3/122; E02B 3/16; E21B 21/01

(57) ABSTRACT

A device to prevent the clay liner erosion of drilling site reserved water and mud waste pits by dissipating the energy of fluid(s) discharged to those pits. An economic and reusable device to prevent the erosion of the compacted clay (marl) layer of water reserve and drilling fluid waste pits at onshore drill sites by dissipating the energy of the fluids and/or solids discharged into the pits. The device consists of an approximately several square meters of rectangular lining that can be manufactured from synthetics, composite, or metal which is securely anchored under the fluid discharge pipes so that it safely dissipates the energy of the fluids/solids discharged into the pit thus preventing the underlying clay (marl) liner erosion and hence water loss or contamination of the underlying soil and shallow groundwater.

### TECHNICAL FIELD

Embodiments relate to devices for preventing soil erosion, and more specifically to a device for preventing marl erosion in reserved water and mud waste pits at drilling sites.

### BACKGROUND

Geosynthetic materials include geotextiles, geomembranes, geogrids, geonets, geocomposites, geosynthetic clay liners, geopipe, geofoam structures, and the like. These products have a wide range of applications and are currently used in many civil and geotechnical engineering applications including roads, airfields, railroads, embankments, retaining structures, reservoirs, canals, dams, bank protection and coastal engineering.

Geomembranes are impermeable membranes widely used as cut-offs and liners in canals, ponds, and wastewater lagoons. One of the largest current applications is at landfill sites for the containment of hazardous or municipal wastes and their leachates to prevent wastes from reaching grounds water supplies. In many of these applications, geomembranes are employed with geotextiles or mesh underliners which reinforce or protect the more flexible geomembrane whilst also acting as an escape route for gases and leachates generated in certain wastes. Commercial geomembranes are made of Low-Density Polyethylene (LDPE), High-Density Polyethylene (HDPE), Polyvinyl Chloride (PVC), Polyurea, and Polypropylene (PP). Another type of geomembrane is bituminous geomembrane, which is actually a layered product of glass and bitumen-impregnated non-woven geotextile.

Underground storm water storage systems store and release water at a controlled rate per the increasingly stringent environmental requirements. Various shaped or molded water containment structures made of concrete, steel or plastic have been employed underground to capture storm water. Plastic storage systems offer unique advantages including lower weight, ease of installation and more freedom in design. The drawbacks of existing plastic storage systems lie in several aspects. First, the relatively low modules and creep strength of plastics compared with concrete increases the potential for failure in the field. In practice there have been reported collapses of HDPE storm water storage structures a few months after installation, due to the creep of HDPE under the pressure coming from backfill as well as structures and/or automobiles above the ground. Therefore, improving the modulus and creep performance of plastic storage system is desired to ensure its use life. Second, in case of storage systems installed below a parking lot, the run-off from the parking lot quite often contains oil, gasoline, anti-freeze and other types of chemicals. Therefore, it is desired to improve the chemical resistance of the storage system.

Conventional lagoon based wastewater treatment systems rely generally on open air lagoons to permit aerobic and anaerobic treatment of wastewater. A lagoon is any earthen basin for containing a body of water, such as a treatment reactor cell. Lagoons and other wastewater treatment ponds or basins are typically constructed by excavating land to create a reservoir area. If desired, berms can then be built around the perimeter of the reservoir area to extend the walls of the reservoir above ground level. Quite often, a lagoon is lined with a layer of clay to serve as a barrier. For example, environmental regulations typically require a subgrade clay layer of uniform thickness, for example 5 feet thick and having uniform water content. Often times a plastic liner made of high-density polyethylene (HDPE) may be placed over the entire interior surface defined by the reservoir and the berm area. The liner is made of sheet strips of high density polyethylene (HDPE) which overlap in an abutting fashion and are then welded or cemented together to create a water impermeable and erosion control line.

Once the lagoon is constructed and lined the wastewater liquid or sludge material is then pumped into the lagoon on top of the liner and/or the clay which is lining the lagoon. This liner facilitates not only maintaining the wastewater in the reservoir or lagoon but also in maintaining any turbulent water flow in the surface from eroding the berm and banking of the lagoon. The lagoon or pond is the subject to water fluid level changes as well as a turbulence of the surface in particular from aeration of the wastewater which can erode the banking and the berm. The liner is instrumental in protecting the underlying clay and soil lining forming the lagoon particularly where the turbulent water contacts the berm and banking.

Lagoon based water treatment systems require a large amount of space, on the order of several acres and often necessitate the large interior encompassing liner in conjunction with the lagoon construction to facilitate containment of the wastewater and to prevent erosion of the banking around the lagoon. This is tremendously expensive where an entire lagoon system must be covered with a liner, not only upon initial construction but upon replacement or fixing of a compromised liner.

Such traditional lagoon-based liner systems have several shortcomings. Because of the large size of the liners where the liners cover the entire interior of the lagoon, the liners which are generally impermeable material must be constructed on-site usually in large strips, where the strips are heat sealed together along their edges after being placed in an empty a lagoon. This of course means that the lagoon must be emptied and cannot be used for the time period in which the new liner material is placed inside. It is tremendously labor intensive, time-consuming and expensive to assemble such liners and empty the lagoons if a liner needs to be fixed or replaced.

In the oil and gas industry, in order to prevent freshwater loss and contamination of the underlying soil and shallow groundwater, water reserve and drilling mud waste pits at drilling sites are lined with marl with a minimum of 0.3 m thickness compacted to 95% of the maximum modified proctor density, as determined by ASTM D1557, to meet a permeability requirement of <10⁻⁵ cm/sec. However, the energy of the fluids and/or solids discharged into the pits from the discharge pipes readily erodes the marl lining, thus creating unwanted hydraulic connectivity that leads to freshwater loss and/or subsurface contamination with hazardous chemicals, as shown in FIG. 1, for example.

### SUMMARY

Accordingly, one embodiment is a device for preventing erosion in a confined portion of a temporary structure (pit) caused by a point source flow e.g., from pipe(s) by using a relatively small reusable device. The device may be made of plastic, steel, metal, or any material with sufficient mechanical strength and resilience to withstand the force of the flow. The device also has improved chemical resistance so that the performance is not adversely affected by most common chemicals encountered in a waste containment environment.

According to one embodiment, the device is configured to prevent the clay liner erosion of drilling site reserved water and mud waste pits by dissipating the energy of fluid(s) discharged to those pits. An economic (reusable) device to prevent the erosion of the compacted clay (marl) layer of water reserve and drilling fluid waste pits at onshore drill sites by dissipating the energy of the fluids and/or solids discharged into the pits. The device includes an approximately several square meters of rectangular lining or water-tight fabric that can be manufactured from synthetics, composite, or metal which is securely anchored under the fluid discharge pipes so that it safely dissipates the energy of the fluids/solids discharged into the pit thus preventing the underlying clay (marl) liner erosion and hence water loss or contamination of the underlying soil and shallow groundwater. The material used to produce the liner is strong enough to withstand the energy of the discharge and allow for safe anchoring of the device. To ensure marl protection, the geometric center of the device must be securely anchored under the discharge pipes with anchors located outside the pit so that the device can be safely retrieved for reuse.

### BRIEF DESCRIPTION OF THE DRAWINGS

So that the manner in which the features, advantages and objects of the invention, as well as others which may become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only example embodiments of the invention and is therefore not to be considered limiting of its scope as the invention may admit to other equally effective embodiments.

FIG. 1 illustrates erosion of the lining of a waste pit from the energy of the fluids discharged into the pit, according to the teachings of prior art.

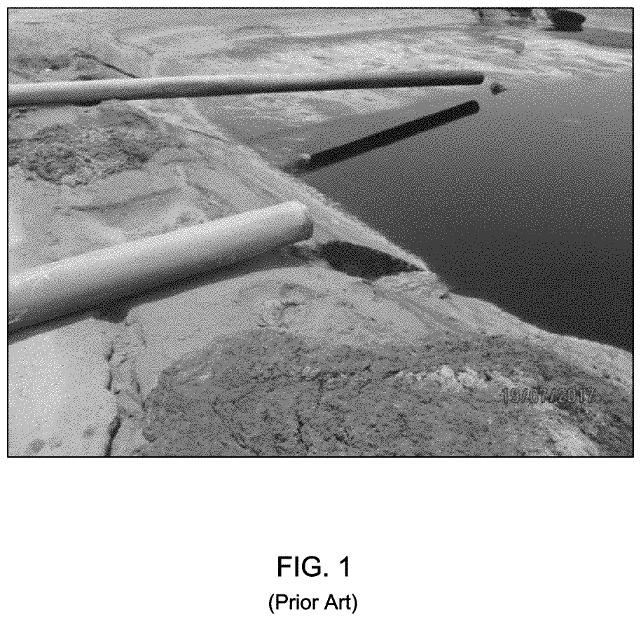

FIG. 2 illustrates a schematic side view of a marl erosion prevention device, according to one example embodiment of the disclosure.

FIG. 3 illustrates a schematic plan view of the marl erosion prevention device shown in FIG. 2.

### DETAILED DESCRIPTION

The methods and systems of the present disclosure will now be described more fully hereinafter with reference to the accompanying drawings in which embodiments are shown. The methods and systems of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout.

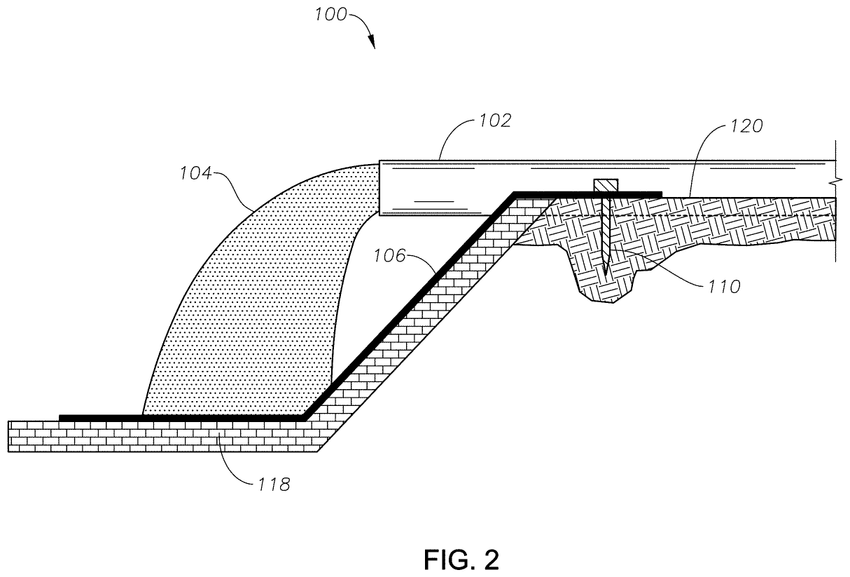

Turning now to the figures, FIG. 2 illustrates a system 100 for prevention of marl erosion in a reserved water or mud waste pit at a drilling site, according to one example embodiment of the disclosure. The system 100 includes a discharge pipe 102 for discharging a waste fluid 104 from a drilling operation (not shown). The system 100 also includes a protective liner 106 disposed under the discharge pipe 102, and a plurality of anchors 110 for anchoring the protective liner to the ground/earth 120 on either sides of the discharge pipe 102.

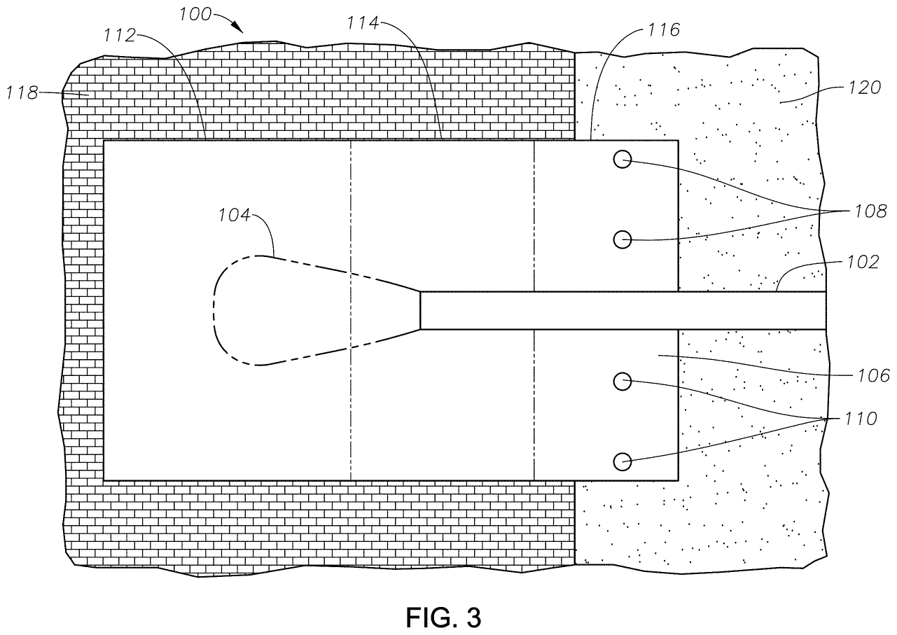

As illustrated in FIG. 3, the protective liner includes a first portion 112 configured to directly receive waste fluid 104 coming from the discharge pipe 102. As illustrated in this figure, the entire first portion 112 covers compacted marl 118 in the pit. A second portion 114 lies below an exit point of the discharge pipe 102 from which the waste fluid 104 is discharged. A third portion 116 lies beneath the discharge pipe 102, and the third portion 116 is anchored to the ground/earth 120 on either sides of the discharge pipe 102 using at least a plurality of anchors 108, 110 on either sides. As illustrated in FIG. 3, the protective liner 106 is configured to dissipate energy of the waste fluid 104 discharged into the pit, thereby preventing marl erosion and water loss or contamination of the soil under the marl and shallow groundwater. The protective liner 106 is installed in such a way that the geometric center of the protective liner 106 is securely anchored under the discharge pipe 102 with the plurality of anchors 108, 110 located outside the pit so that the device/liner 106 can be safely retrieved for reuse. As it may be apparent to one of ordinary skill in the art, the waste mud pit begins where the marl 118 starts sloping downwards (seen in FIG. 2).

According to one embodiment, the protective liner 106 may include a woven fabric, an extruded mesh, a non-woven fabric, an extruded film, a composite fabric, or combinations thereof. The protective liner 106 may be made of a material selected from the group consisting of Low-Density Polyethylene (LDPE), High-Density Polyethylene (HDPE), Polyvinyl Chloride (PVC), Polyurea, Polypropylene (PP), steel, metal, glass, Kevlar, carbon, and nanocomposites.

The term “marl” as used herein refers to marl or marlstone is a calcium carbonate or lime-rich mud or mudstone which contains variable amounts of clays and silt. The dominant carbonate mineral in most marls is calcite, but other carbonate minerals such as aragonite, dolomite, and siderite may be present. Marl may also refer to earthy deposits consisting chiefly of an intimate mixture of clay and calcium carbonate, formed under freshwater conditions, specifically an earthy substance containing 35-65% clay and 65-35% carbonate. It may also refer to indurated marine deposits and lacustrine (lake) sediments which more accurately should be named ‘marlstone’. Marlstone is an indurated (resists crumbling or powdering) rock of about the same composition as marl, more correctly called an earthy or impure argillaceous limestone. It has a blocky subconchoidal fracture, and is less fissile than shale.

One embodiment is a method for prevention of marl erosion in a reserved water or mud waste pit at a drilling site. The method includes installing a protective liner under a discharge pipe for receiving a waste fluid from a drilling operation. The next step involves anchoring, using a plurality of anchors, the protective liner on either sides of the discharge pipe such that the geometric center of the protective liner is securely anchored under the discharge pipe with the plurality of anchors located outside the pit so that the device can be safely retrieved for reuse.

As illustrated in FIG. 3, the protective liner includes a first portion 112 configured to directly receive waste fluid 104 coming from the discharge pipe 102. As illustrated in this figure, the entire first portion 112 covers compacted marl 118 in the pit. A second portion 114 lies below an exit point of the discharge pipe 102 from which the waste fluid 104 is discharged. A third portion 116 lies beneath the discharge pipe 102, and the third portion 116 is anchored to the ground/earth 120 on either sides of the discharge pipe 102 using at least a plurality of anchors 108, 110 on either sides.

As illustrated in FIG. 3, the protective liner 106 is configured to dissipate energy of the waste fluid 104 discharged into the pit, thereby preventing marl erosion and water loss or contamination of the soil under the marl and shallow groundwater. The protective liner 106 is installed in such a way that the geometric center of the protective liner 106 is securely anchored under the discharge pipe 102 with the plurality of anchors 108, 110 located outside the pit so that the device/liner 106 can be safely retrieved for reuse.

According to one embodiment, the protective liner 106 may include a woven fabric, an extruded mesh, a non-woven fabric, an extruded film, a composite fabric, or combinations thereof. The protective liner 106 may be made of a material selected from the group consisting of Low-Density Polyethylene (LDPE), High-Density Polyethylene (HDPE), Polyvinyl Chloride (PVC), Polyurea, Polypropylene (PP), steel, metal, glass, Kevlar, carbon, and nanocomposites.

Another embodiment is a device or protective liner for prevention of marl erosion in a reserved water or mud waste pit at a drilling site. The device or protective liner has a length and a width, the length being greater than the width of the protective liner. As illustrated in FIG. 3, the protective liner includes a first portion 112 configured to directly receive waste fluid 104 coming from the discharge pipe 102. As illustrated in this figure, the entire first portion 112 covers compacted marl 118 in the pit. A second portion 114 lies below an exit point of the discharge pipe 102 from which the waste fluid 104 is discharged. A third portion 116 lies beneath the discharge pipe 102, and the third portion 116 is anchored to the ground/earth 120 on either sides of the discharge pipe 102 using at least a plurality of anchors 108, 110 on either sides. As illustrated in FIG. 3, the protective liner 106 is configured to dissipate energy of the waste fluid 104 discharged into the pit, thereby preventing marl erosion and water loss or contamination of the soil under the marl and shallow groundwater. The protective liner 106 is installed in such a way that the geometric center of the protective liner 106 is securely anchored under the discharge pipe 102 with the plurality of anchors 108, 110 located outside the pit so that the device/liner 106 can be safely retrieved for reuse. As it may be apparent to one of ordinary skill in the art, the waste mud pit begins where the marl 118 starts sloping downwards (seen in FIG. 2).

According to one embodiment, the protective liner 106 may include a woven fabric, an extruded mesh, a non-woven fabric, an extruded film, a composite fabric, or combinations thereof. The protective liner 106 may be made of a material selected from the group consisting of Low-Density Polyethylene (LDPE), High-Density Polyethylene (HDPE), Polyvinyl Chloride (PVC), Polyurea, Polypropylene (PP), steel, metal, glass, Kevlar, carbon, and nanocomposites.

In accordance with the present invention, improved geosynthetic materials including geotextiles, geomembranes, geogrids, geonets, geocomposites, geosynthetic clay liners, geopipe and geofoam made of polymer silicate nanocomposites are provided. Compared with systems made of virgin plastics, these new systems provide a unique combination of higher chemical resistance, lower methane and radon transmission, improved creep strength, lower coefficient of thermal expansion, higher puncture strength and elastic modulus. In addition to the improved properties, this approach allows for greater use of recycled virgin plastics or nanocomposites from both post-consumer and post-industrial sources in the feed stream without compromising the final properties.

The device disclosed above has lower gas transmission, which is desired for methane, radon, water vapor, and the like. The device also has improved chemical resistance so that the performance is not adversely affected by most common chemicals encountered in a waste containment environment.

The anti-erosion device disclosed in the above embodiments is directly applicable to any onshore drilling and workover drilling sites where the primary compacted clay (marl) liner of water reserve and drilling fluid waste pits is not protected with a secondary protective liner (e.g. thermally welded high density polyethylene (HDPE)).

There are several advantages of the anti-erosion device disclosed herein. Some non-limiting examples include that the device simplifies the protection of the primary compacted clay (marl) liner of the said pits (both in terms of time and resources saved) thereby ensuring the layer integrity and hence preventing the loss of fresh water to infiltration or the contamination of soil and shallow groundwater under the pit with hazardous liquids. Additionally, the device disclosed herein is an economical alternative to lining the entire pits with a secondary protective liner as now practiced at specific locations.

Examples of an anti-erosion device are disclosed above, and the embodiments disclosed may be utilized outside of water reserve/waste pits at onshore drilling rigs. For example, the embodiments disclosed could be used in agriculture, landfilling, or any other area where storage and/or disposal of fluids/solids into earthen pits from discharge pipes is practiced.

The Specification, which includes the Summary, Brief Description of the Drawings and the Detailed Description, and the appended Claims refer to particular features (including process or method steps) of the disclosure. Those of skill in the art understand that the invention includes all possible combinations and uses of particular features described in the Specification.

Those of skill in the art understand that the disclosure is not limited to or by the description of embodiments given in the Specification.

Those of skill in the art also understand that the terminology used for describing particular embodiments does not limit the scope or breadth of the disclosure. In interpreting the Specification and appended Claims, all terms should be interpreted in the broadest possible manner consistent with the context of each term. All technical and scientific terms used in the Specification and appended Claims have the same meaning as commonly understood by one of ordinary skill in the art to which this invention belongs unless defined otherwise.

As used in the Specification and appended Claims, the singular forms “a,” “an,” and “the” include plural references unless the context clearly indicates otherwise. The verb “comprises” and its conjugated forms should be interpreted as referring to elements, components or steps in a non-exclusive manner. The referenced elements, components or steps may be present, utilized or combined with other elements, components or steps not expressly referenced. The verb “operatively connecting” and its conjugated forms means to complete any type of required junction, including electrical, mechanical or fluid, to form a connection between two or more previously non-joined objects. If a first component is operatively connected to a second component, the connection can occur either directly or through a common connector. “Optionally” and its various forms means that the subsequently described event or circumstance may or may not occur. The description includes instances where the event or circumstance occurs and instances where it does not occur.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The systems and methods described herein, therefore, are well adapted to carry out the objects and attain the ends and advantages mentioned, as well as others inherent therein. While example embodiments of the system and method have been given for purposes of disclosure, numerous changes exist in the details of procedures for accomplishing the desired results. These and other similar modifications may readily suggest themselves to those skilled in the art, and are intended to be encompassed within the spirit of the system and method disclosed herein and the scope of the appended claims.

1. A system for prevention of marl erosion in a reserved water or mud waste pit at a drilling site, the system comprising:
a discharge pipe for discharging a waste fluid from a drilling operation;
a protective liner disposed under the discharge pipe, wherein the protective liner is a secondary protective liner laid on top of a primary compacted marl or clay liner; and
a plurality of anchors configured to anchor the protective liner on either sides of the discharge pipe.

2. The system of claim 1, wherein the protective liner has a length and a width, wherein the length is greater than the width of the protective liner.

3. The system of claim 1, wherein the protective liner further comprises:
a first portion configured to directly receive waste fluid from a discharge pipe, the entire first portion covering compacted marl in the pit;
a second portion that lies below an exit point of the discharge pipe from which the waste fluid is discharged; and
a third portion that lies beneath the discharge pipe, wherein the third portion is anchored to the soil on either sides of the discharge pipe using the plurality of anchors.

4. The system of claim 1, wherein the protective liner is configured to dissipate energy of the waste fluid discharged into the pit, thereby preventing marl erosion and water loss or contamination of the soil under the marl and shallow groundwater.

5. The system of claim 1, wherein the geometric center of the protective liner is securely anchored under the discharge pipe with the plurality of anchors located outside the pit so that the device can be safely retrieved for reuse.

6. The system of claim 1, wherein the protective liner comprises a woven fabric, an extruded mesh, a non-woven fabric, an extruded film, a composite fabric, or combinations thereof.

7. The system of claim 1, wherein the protective liner comprises a material selected from the group consisting of Low-Density Polyethylene (LDPE), High-Density Polyethylene (HDPE), Polyvinyl Chloride (PVC), Polyurea, Polypropylene (PP), steel, metal, glass, Kevlar, carbon, and nanocomposites.

8. A method for prevention of marl erosion in a reserved water or mud waste pit at a drilling site, the method comprising:
installing a protective liner under a discharge pipe for receiving a waste fluid from a drilling operation, wherein the protective liner is a secondary protective liner laid on top of a primary compacted marl or clay liner; and
anchoring, using a plurality of anchors, the protective liner on either sides of the discharge pipe such that the geometric center of the protective liner is securely anchored under the discharge pipe with the plurality of anchors located outside the pit so that the device can be safely retrieved for reuse.

9. The method of claim 8, wherein the protective liner has a length and a width, wherein the length is greater than the width of the protective liner.

10. The method of claim 8, wherein the protective liner further comprises:
a first portion configured to directly receive waste fluid from a discharge pipe, the entire first portion covering compacted marl in the pit;
a second portion that lies below an exit point of the discharge pipe from which the waste fluid is discharged; and
a third portion that lies beneath the discharge pipe, wherein the third portion is anchored to the soil on either sides of the discharge pipe using the plurality of anchors.

11. The method of claim 8, wherein the protective liner is configured to dissipate energy of the waste fluid discharged into the pit, thereby preventing marl erosion and water loss or contamination of the soil under the marl and shallow groundwater.

12. The method of claim 8, wherein the protective liner comprises a woven fabric, an extruded mesh, a non-woven fabric, an extruded film, a composite fabric, or combinations thereof.

13. The method of claim 8, wherein the protective liner comprises a material selected from the group consisting of Low-Density Polyethylene (LDPE), High-Density Polyethylene (HDPE), Polyvinyl Chloride (PVC), Polyurea, Polypropylene (PP), steel, metal, glass, Kevlar, carbon, and nanocomposites.

14. A device for prevention of marl erosion in a reserved water or mud waste pit at a drilling site, the device comprising:
a protective liner having a length and a width, the length being greater than the width of the protective liner, the protective liner comprising:
a first portion configured to directly receive waste fluid from a discharge pipe, the entire first portion covering compacted marl in the pit;
a second portion that lies below an exit point of the discharge pipe from which the waste fluid is discharged; and
a third portion that lies beneath the discharge pipe, wherein the third portion is anchored to the soil on either sides of the discharge pipe using a plurality of anchors, wherein the protective liner is a secondary protective liner laid on top of a primary compacted marl or clay liner.

15. The device of claim 14, wherein the protective liner is configured to dissipate energy of the waste fluid discharged into the pit, thereby preventing marl erosion and water loss or contamination of the soil under the marl and shallow groundwater.

16. The device of claim 14, wherein the geometric center of the protective liner is securely anchored under the discharge pipe with the plurality of anchors located outside the pit so that the device can be safely retrieved for reuse.

17. The device of claim 14, wherein the third portion of the protective liner only partially covers the compacted marl in the pit.

18. The device of claim 14, wherein the protective liner comprises a woven fabric, an extruded mesh, a non-woven fabric, an extruded film, a composite fabric, or combinations thereof.

19. The device of claim 14, wherein the protective liner comprises a material selected from the group consisting of Low-Density Polyethylene (LDPE), High-Density Polyethylene (HDPE), Polyvinyl Chloride (PVC), Polyurea, Polypropylene (PP), steel, metal, glass, Kevlar, carbon, and nanocomposites.

20. The device of claim 14, wherein the protective layer further comprises a polymer modifier selected from the group consisting of an antiblocking agent, an antistatic agent, an antioxidant, a blowing agent, a polymer compatiblizer, a crystallization aid, a dye, an extender, a flame retardant, a filler, an impact modifier, a mold release agent, an oil, a pigment, a performance additive, a plasticizer, a processing agent, a reinforcing agent, a polymer stabilizer, an UV light absorber, a photostabilizer for a UV light absorber, and a mixture thereof.
